(19) United States
(12) Patent Application Publication
(10) Pub. No.: US 2018/0131785 A1
(43) Pub. Date: May 10, 2018

(54) REDUCING RESPONSE TIMES TO GATEWAY-CONNECTED DEVICES

(71) Applicant: CA, Inc., New York, NY (US)

(72) Inventors: Suresh Sharma, Rajasthan (IN); Mohammed Naseeruddin, Telangana (IN); Vallinayagam Pitchaimani, Tamilnadu (IN)

(21) Appl. No.: 15/344,706

(22) Filed: Nov. 7, 2016

(51) Int. Cl. H04L 29/08; H04L 29/06

(52) U.S. Cl. CPC H04L 67/32; H04L 65/102; H04L 67/10; H04L 67/42

(57) ABSTRACT

A gateway receives a response to a request from a server before that request is transmitted from the gateway to the server. The gateway is thus preloaded with the response even though the gateway has not issued a corresponding request to the server. Rather, the request was communicated to the server from a different gateway and the server preemptively sent the response to the gateway. Moreover, a server receives a first request from a first gateway representing an event generated from a first device. The server analyzes the request, generates a response, and transmits the generated response to the first gateway. The server also communicates the response to a second gateway upon determining that the event is applicable to a second device associated with the second gateway, the response being communicated to the second gateway before the second gateway transmits a second request representing the event to the server.

### BACKGROUND

### Field of the Disclosure

The present disclosure relates generally to computing devices, and more particularly to reducing response times to gateway-connected devices in gateway-server computing environments.

### Description of the Related Art

Conventional gateway-server environments have gateways that communicate with a server. Each of the gateways also communicates with one or more end devices. Because numerous end devices are often coupled to a single gateway, and because numerous gateways are coupled to a server, the burden on the server affects response times.

### BRIEF SUMMARY

According to aspects of the present disclosure, a computer-implemented process comprises receiving, by a first gateway, a request that is indicative of an event associated with a first end device. By way of example, the request may be received from the first end device. Moreover, the first gateway may be communicably coupled to a server and the first gateway may be communicably coupled to the first device. The computer-implemented process further comprises determining, by the first gateway, whether a response to the event is stored in memory of the first gateway. In this regard, if the response to the event is stored in the memory of the first gateway, the response was obtained by receiving, by the first gateway from a server, the response as a result of the server responding to a previous request indicative of the event from a second gateway. That is, the first gateway received the response from the server even though the first gateway did not forward the corresponding request to the server. Still further, the computer-implemented process comprises transmitting, upon determining that the response is stored in the memory of the first gateway, the response to the first end device.

The computer-implemented process may further comprise performing, upon determining that the response to the request is not stored in the memory of the first gateway, forwarding the request to the server, receiving the response to the request from the server, storing the response in the memory of the first gateway, and transmitting the stored response to the first end device.

According to further aspects of the present disclosure, a computer-implemented process comprises receiving, by a first gateway, a response to an event. Here, the first gateway is communicatively coupled to a server. Also, the first gateway is communicably coupled to a first end device. Moreover, the response is received from the server without the first gateway transmitting to the server, a request for the response. The computer-implemented process also comprises storing the received response at the first gateway.

According to still further aspects of the present disclosure, a computer-implemented process comprises receiving, by a server, a request from a first gateway, the request representing an event generated from a first device in data communication with the first gateway. The computer-implemented process also comprises analyzing, by the server, the received request, and generating a response to the analyzed request. The computer-implemented process still further comprises transmitting the generated response to the first gateway. Moreover, the computer-implemented process comprises determining whether the event is applicable to a second device in data communication with a second gateway, and communicating a second response to the second gateway upon determining that the event is applicable to the second device, the second response being communicated to the second gateway before the second gateway transmits to the server, a second request representing the event. By way of example, the second response can be the same as the response, a modified version of the response such that the second response is applicable to the second gateway, a different but related response, etc.

According to yet further aspects of the present disclosure, a server pushes responses to requests indicative of events from end devices out to multiple gateways that are each communicably coupled to the server. In this regard, a gateway can receive a response to a request from the server without asking for the response, i.e., before that request is forwarded from the gateway to the server. The received response is stored at the gateway, thereby being available for transmission to an end device when needed by the end device. As such, gateway response time back to the end device is improved because the gateway does not have to forward the request to the server and await a response.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

FIG. 1 is a flowchart showing an embodiment of a computer-implemented process for establishing a gateway-server environment;

FIG. 2 is a flowchart showing an embodiment of a computer-implemented process as seen from a perspective of a gateway;

FIG. 3 is a flowchart showing an embodiment of a computer-implemented process as seen from a perspective of a server;

FIG. 4 is a flowchart showing an embodiment of the step of receiving a request from the gateway, which is shown in FIG. 3;

FIG. 5 is a flowchart showing an embodiment of a computer-implemented process, as seen from the perspective of the server, for transmitting an applicable response to a new end device that has been communicatively coupled to a gateway;

FIG. 6 is a flowchart showing an embodiment of a computer-implemented process, as seen from the perspective of the server, for transmitting an updated response to the gateways that are communicatively coupled to the server;

FIG. 7 is a flowchart showing an embodiment of a computer-implemented process, as seen from the perspective of the gateway, for updating the server when a new end device is communicatively coupled to the gateway or a previously-coupled end device is uncoupled from the gateway;

FIG. 8 is a flowchart showing an embodiment of the computer-implemented process of forwarding the request to the server, which is shown in FIG. 2;

FIG. 9 is a flowchart showing an embodiment of the computer-implemented process of storing the response, which is shown in FIG. 2;

FIG. 10 is a flowchart showing another embodiment of a computer-implemented process, as seen from the perspective of the gateway;

FIG. 11 is a flowchart showing yet another embodiment of a computer-implemented process, as seen from the perspective of the gateway;

FIG. 12 is a diagram showing an embodiment of a gateway-server environment; and

FIG. 13 is a diagram showing an embodiment of a schematic of a computer system comprising computer readable program code for executing any aspects described herein with regard to FIGS. 1 through 12.

### DETAILED DESCRIPTION

A gateway-server environment comprises gateways that communicate with a server. Each of the gateways also communicates with one or more end devices (or user devices). If an event that requires a response occurs at a particular end device, then that end device conveys a request to the associated gateway based on the occurrence of the event. The gateway acts as a facilitator and forwards the request to the server (or forwards a version of the request that can be handled by the server to the server). Upon receiving the request, the server generates a response to the event. The generated response is transmitted to the gateway, which in turn transmits the response to the particular end device (or transmits a device-specific version of the response to the particular end device).

Because numerous end devices are often communicably coupled (i.e., logically connected) to a single gateway, and because numerous gateways are coupled to a server, the server can potentially receive copious amounts of requests. Each request consumes some amount of processing power and some amount of processing time at the server. Thus, response times are affected directly by the number of requests that the server handles. Additionally, the data path between the end device and the server via the gateway adds to latency, thereby further affecting response times.

Sometimes, the server receives substantially duplicative requests that are generated as a result of separate, but potentially related events at different end devices. This can even sometimes occur in response to multiple end devices encountering the same occurrence of an event-triggering activity. Even though the response may be the same for each of these duplicative requests, the server typically nevertheless treats each request separately and generates a response to each of the requests separately.

Accordingly, certain disclosed embodiments reduce some of the inefficiencies associated with forcing a server to handle duplicative requests. Additionally, certain disclosed embodiments drastically reduce the latency in a gateway receiving an event from an end device, with regard to returning an appropriate response. Still further, certain disclosed embodiments reduce noise and traffic involved in gateway to server communication by eliminating redundant server requests that might otherwise be communicated to the server from multiple, distinct gateways.

In an embodiment herein, a server pushes responses to various gateways in pre-emptive manner. In this regard, a gateway can receive a response to a request from a server before that request is transmitted from the gateway to the server (e.g., even before that request is received by the gateway from an attached end device). Here, the received response is stored at the gateway, and is thus available for transmission to an end device when needed. For instance, once the server receives a request from a first gateway, the server can push the response to the request out to multiple gateways so that some gateways have the response “queued up” in case an attached end device issues a corresponding request.

In another embodiment, a server receives a request from one gateway (based on an event at one end device) and determines whether a response to the request is applicable to other end devices. If the response is applicable to other end devices, then the server transmits the response to all of the gateways that are in communication with the applicable end devices. Making the response available directly from the gateway reduces the inefficiencies that previously existed with reference to handling substantially duplicative requests.

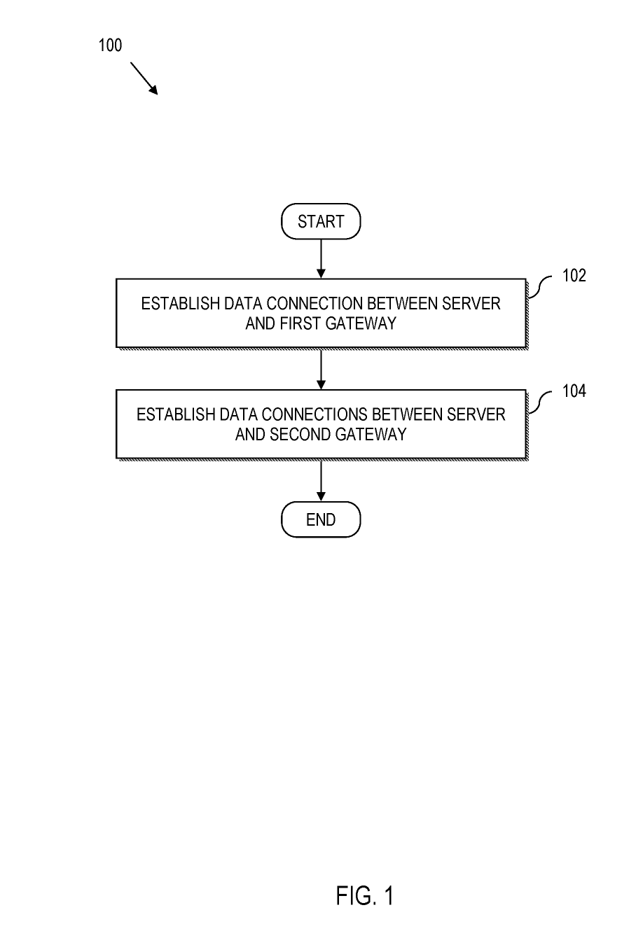

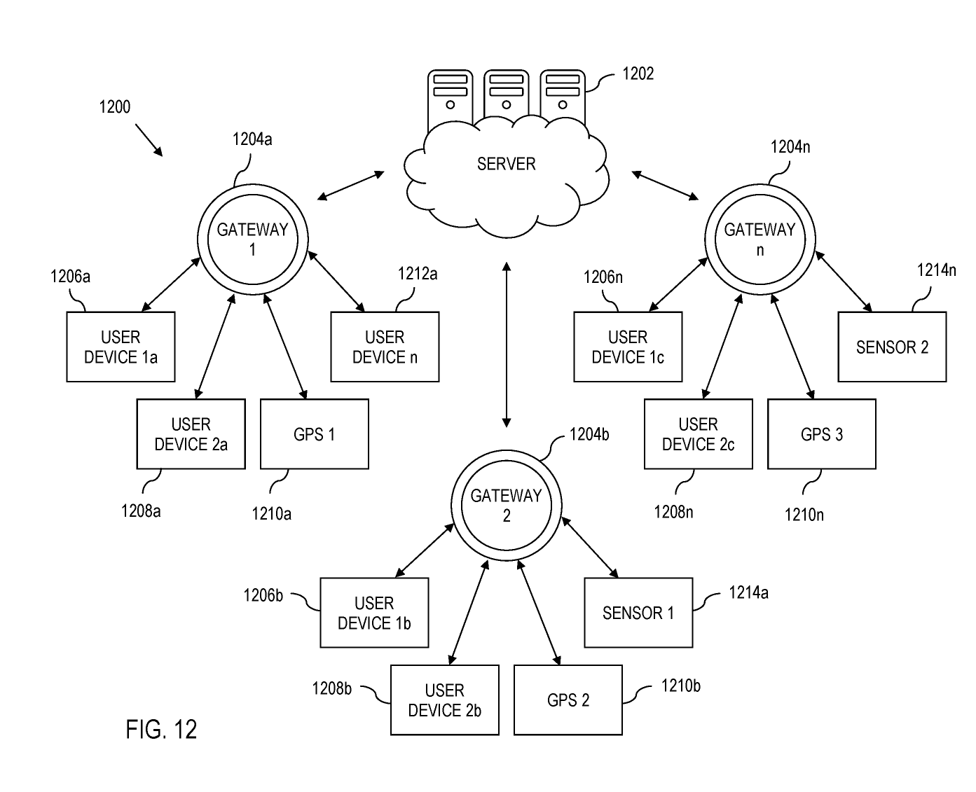

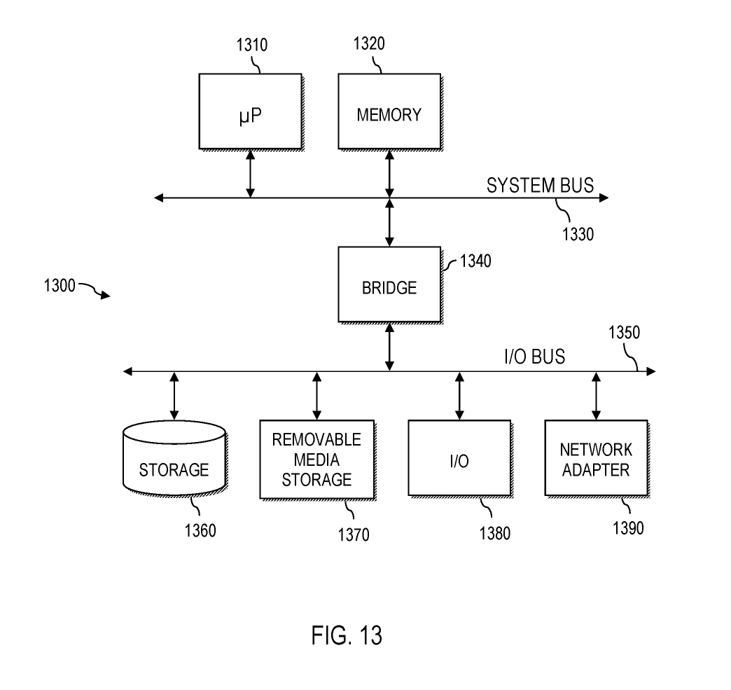

Having provided a broad description of several embodiments, reference is now made in detail to the description of the embodiments as illustrated in the drawings. Specifically, FIGS. 1 through 11 are flowcharts showing various embodiments of gateway-server processes, FIG. 12 is a block diagram showing an example embodiment of a gateway-server environment, and FIG. 13 is a block diagram showing an example embodiment of a computer system by which a server, a gateway, or an end device (or user device) is implemented. While several embodiments are described in connection with these drawings, there is no intent to limit the disclosure to the embodiment or embodiments disclosed herein. On the contrary, the intent is to cover all alternatives, modifications, and equivalents.

FIGS. 1 through 11 are flowcharts illustrating several embodiments of gateway-server processes (i.e., computer-implemented processes). Each illustrated computer-implemented process may be carried out, for instance, as computer-readable hardware (e.g., computer-readable hardware memory, computer readable storage media, etc.) comprising computer instructions (e.g., in the form of program code) that instruct a processor to implement the described computer-implemented process. In this regard, the flowchart outlines an algorithm that is executed by the processor.

Referring now to FIG. 1, a flowchart illustrates an embodiment of a computer-implemented process 100 for establishing a gateway-server environment with multiple gateways connected (i.e., logically connected, and thus communicably coupled as defined herein) to a server. The computer-implemented process 100 of FIG. 1 is a preliminary process that results in the server becoming aware of multiple gateways, each gateway communicating with one or more end devices.

As shown in FIG. 1, the computer-implemented process 100 comprises establishing at 102, a data connection between a server and a first gateway and, also, establishing at 104, a data connection between the server and a second gateway. As used herein, each “data connection” simply refers to a logical connection, and thus refers to the ability of the server and the gateway to be aware of each other and communicate with each other. In this regard, a data connection need not be a continuously connected relationship. For instance, the server and first gateway may communicate using the hypertext transfer protocol (HTTP), which is connectionless. Even though connectionless, the gateway and the server are aware of, and capable of communicating with each other. In this regard, the disclosure herein refers to this relationship of being able to communicate with, as being “communicably coupled” or “communicably connected”, attached, etc.

The above computer-implemented process is useful for instance, in an Internet of things (IoT) device deployment scenario to inform an IoT server of the availability of IoT gateways. Here, IoT end devices (e.g., sensors, smart encoders or specialized electronics, smart appliances, smart phones, dedicated hardware processing devices, etc.) may use different protocols to connect and communicate. Non-limiting examples include Wi-Fi, Ultrawide band, Bluetooth, Zigbee, etc. Moreover, each IoT end device may connect to different control environment and have different models for management and security. As such, it is common that IoT end devices cannot directly communicate with server computer. To address this issue, the IoT gateway provides an intermediate between such IoT end devices and a corresponding IoT server. For instance, each of the IoT end devices are communicably coupled to an associated one of a plurality of IoT gateways. Each IoT gateway is in turn communicably coupled to the server, such as an IoT platform hosted on a cloud computing structure.

In this configuration, each IoT gateway collects data from the connected IoT end devices, performs device connectivity, protocol translation, data aggregation, event processing, filtering of data etc. Each gateway further communicates to the server (IoT Platform hosted on cloud). The server analyzes the data received from the IoT gateways and decides the responses that need to be sent back to the corresponding IoT gateway and the corresponding IoT end devices.

Thus, the computer-implemented process 100 allows the server to keep track of the gateways which the server manages. Moreover, the server can manage the number of gateway devices, e.g., end devices such as device or sensors attached to the gateway. Still further, in some embodiments, the server can manage historical data about the events and request/response handled. For some embodiments, the server establishes connections with multiple different gateways.

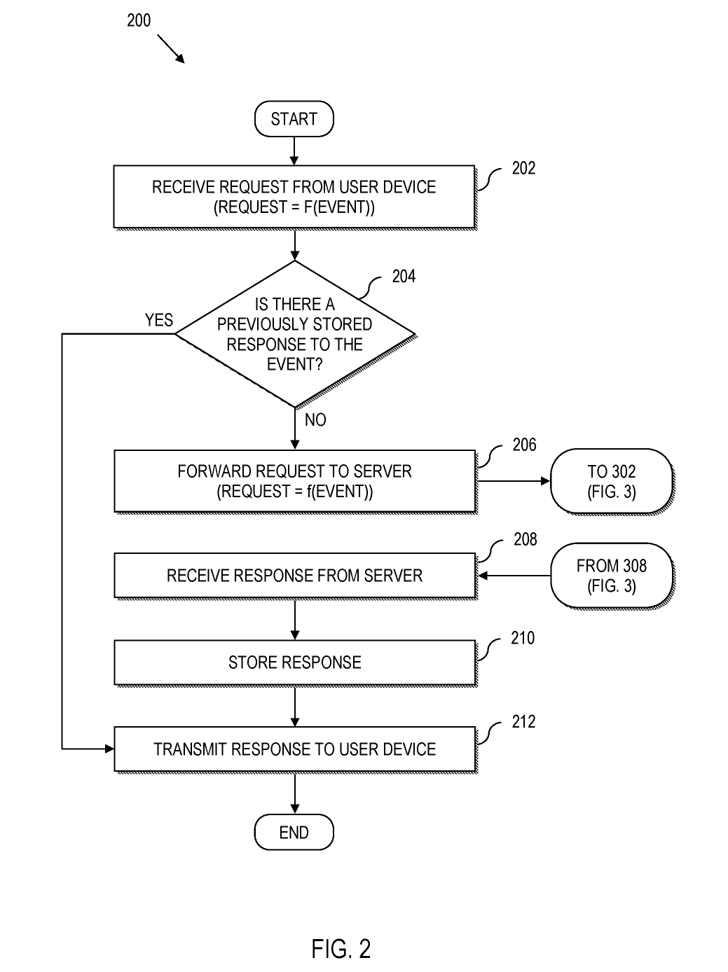

Referring now to FIGS. 2 through 11, several embodiments illustrate processes that reduce response times to gateway-connected devices. To be clear, the computer-implemented processes of FIGS. 2 through 11 take place in an environment that comprises a server that is communicatively coupled to multiple gateways, e.g., where each gateway independently communicates with the server. Again, “communicably coupled” simply means that the server is capable of communication with the corresponding gateways.

FIG. 2 is a flowchart illustrating an embodiment of a computer-implemented process 200 as seen from a perspective of a gateway. The computer-implemented process 200 can be implemented by a processor of a gateway that is communicably coupled to a server. The computer-implemented process comprises receiving at 202, by a first gateway, a request that is indicative of an event associated with a first end device. For instance, the request can be received from the first end device. Moreover, in some embodiments, the first gateway is communicatively coupled to the first end device, and the first gateway is communicably coupled to a server. Thus, for example, if the first end device is a global positioning system (GPS), then the event may be an indication of a traffic jam, a route change, etc. Thus, a corresponding request would be a request for a new route, a request for an updated map of traffic conditions, etc.

Upon receiving the request, the computer-implemented process comprises determining at 204, by the first gateway, whether a response to the event is stored in memory of the first gateway. In some embodiments, the first response is already stored in the memory of the first gateway when a comparable event has occurred in another end device that is communicably coupled to the same or a different gateway. Here, the first gateway would have received the response from the server before the request is received from the first user device. Thus, in an illustrative embodiment, if the response to the event is stored in the memory of the first gateway, the response was obtained by receiving, by the first gateway from a server, the response as a result of the server responding to a previous request indicative of the event from a second gateway. In another embodiment, the first response may alternatively be received from the server and stored in the memory in response to a previous request indicative of the first event being transmitted to the server by the first gateway itself.

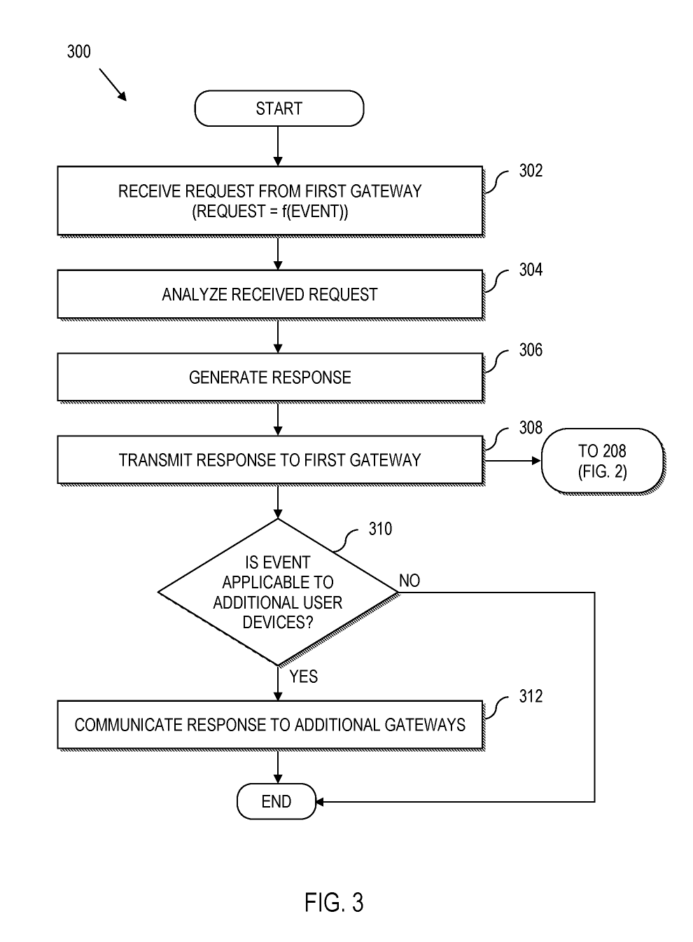

If the computer-implemented process determines at 204 that there is no previously-stored response at the gateway, then the computer-implemented process comprises forwarding at 206 the request to the server. The flow of data processing then continues to FIG. 3, which shows an embodiment of a computer-implemented process 300 as seen from a perspective of a server (discussed in detail below). It should be noted that the gateway acts as a facilitator between end devices that are communicably coupled to the gateway and the server. As such, when the gateway forwards the request to the server, the gateway sometimes converts the device-specific requests into a format that is recognizable by the server.

Keeping with FIG. 2, the computer-implemented process 200 executed by the gateway performs receiving at 208, a response from the server.

The computer-implemented process 200 executed by the gateway also comprises storing at 210 the response in the memory of the gateway.

The computer-implemented process also comprises transmitting the stored response at 212 to the end device, thereby ending this embodiment of the computer-implemented process 200. Likewise, with reference back to determining at 204, if there is a previously-stored response that exists at the first gateway, then the computer-implemented process 200 comprises transmitting at 212, that previously stored response to the end device.

In an example implementation, forwarding the request to the server comprises forwarding to the server a device identifier. In this implementation, the device identifier is indicative of a device type that corresponds to the first end device. Moreover, forwarding the request comprises forwarding to the server an event identifier corresponding to the event.

In yet another example implementation, transmitting the stored response to the end device comprises transmitting an action corresponding to the first event.

In still yet another example implementation, storing the response in the memory of the gateway comprises storing an event identifier, storing a device identifier, and storing data corresponding to the event. In this example implementation, the event identifier corresponds to the event, the device identifier corresponds to the first end device, and the data further corresponds to the first end device, an action corresponding to the event, or both.

In yet further example implementations, the computer-implemented process 200 can further comprise determining whether the first end device has been uncoupled from the first gateway, and transmitting, upon determining that the first end device has been uncoupled from the first gateway, a notice to the server. Here, the first end device can uncouple from the first gateway by logging out of the gateway, or otherwise causing the first gateway to terminate a communication status with the first end device. For instance, the first gateway can remove the first end device from a list of active devices designating end devices that are logged into the first gateway.

Likewise, the computer-implemented process 200 can further comprise determining whether a new end device has been communicatively coupled to the first gateway, and transmitting, upon determining that the new end device has been communicatively coupled to the first gateway, a notice to the server.

The computer-implemented process 200 can still further comprise receiving, by the first gateway, a second response to a second event, the second response being received from the server without the first gateway transmitting a second request for the second response, and storing the second response at the first gateway. Examples of the above optional embodiments are set out in greater detail herein.

Referring to FIG. 3, a computer-implemented process 300 is seen from the perspective of the server. The computer-implemented process 300 may be initiated for instance, in response to forwarding (206, FIG. 2) the first request to the first server.

In this regard, the computer-implemented process can be carried out by a processor of the server, which is coupled to memory that stores program code that when executed, performs receiving at 302, the request from the gateway and analyzing at 304 the request. The computer-implemented process 300 further comprises thereafter generating at 306 a response and transmitting at 308, the generated response to the gateway. Upon transmitting the response at 308, the computer-implemented process 300 may return to receiving the response (208, FIG. 2) if the computer-implemented process 300 was initiated by the computer-implemented process 200.

In addition to transmitting at 308, the generated response to the gateway from which the request originated, the computer-implemented process 300 further comprises determining at 310 whether or not the event (which resulted in the response) is applicable to additional end devices. As noted more fully herein, the server is communicably coupled to multiple gateways, which are in turn communicably coupled to multiple end devices. Consequently, the server potentially processes requests from all of those gateway-connected end devices, many of which can be the same or comparable devices. By way of example, it is sometimes likely that the server responds to numerous GPS devices that are coupled to numerous different gateways. As a result, if one GPS device has an event that is indicative of a traffic accident, then other GPS devices in geographical proximity to the first GPS device are likely to also have the same event because those GPS devices will all be affected by that same traffic accident. When such an overlap exists, the server will determine that the event (e.g., traffic accident) is applicable to other end devices.

Thus, continuing with FIG. 3, if the computer-implemented process determines at 310 that the event is not applicable to any additional end devices, then the computer-implemented process 300 at the server ends. If, on the other hand, the computer-implemented process determines 310 that the event is applicable to additional end devices, then the computer-implemented process comprises communicating at 312, the generated response to at least one (e.g., typically all of the additional gateways to which the applicable end devices are coupled). By communicating at 312 the response to the additional gateways, the gateways have the ability to provide responses to their respective end devices without querying the server. If there is a previously-stored response at the gateway, then there is no longer a need to query the server for a response, thereby reducing response times between the request and the response to the end device. Specifically, by avoiding a query to the server, latencies associated with data transmission and server processing are eliminated.

In an example implementation, receiving at 302, by the server, the request from the gateway can comprise receiving an event identifier, the event identifier being indicative of the event, and receiving a device identifier, the device identifier corresponding to the first device, the device identifier further corresponding to applicable additional devices (e.g., other instances of the same type of sensor, etc.). Here, transmitting the response to the gateway at 308 can optionally further comprise transmitting an executable script, the executable script configured to generate data, the generated data being responsive to the request. In other embodiments, the response can comprise a data range, an array of device specific responses, etc.

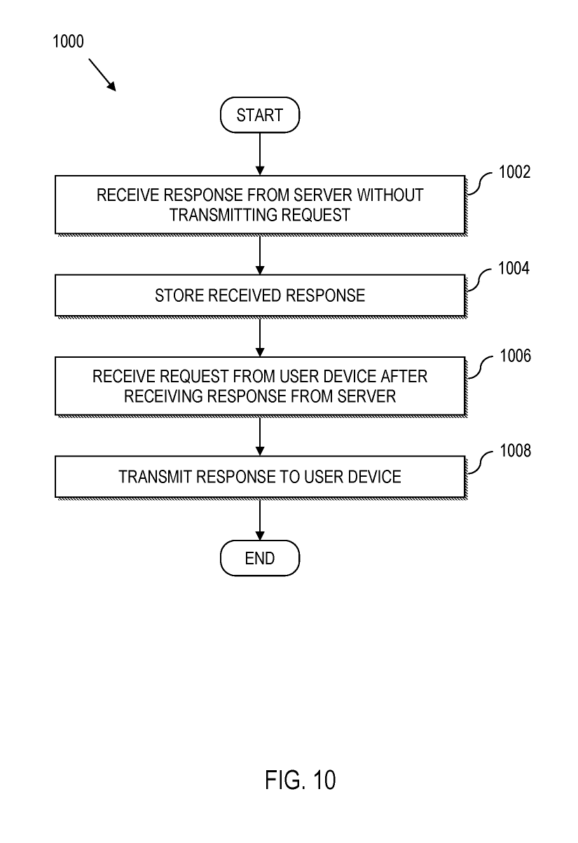

In yet another example implementation, the computer-implemented process 300 can further comprise receiving a new notice of a new device from an additional gateway, determining, upon receiving the new notice, whether the event is applicable to the new device, and transmitting the response to the additional gateway upon determining that the event is applicable to the new device. The computer-implemented process 300 can also and/or alternatively further comprise determining whether an update to the response is needed, updating, upon determining that the update is needed, the response to generate an updated response, and transmitting the updated response to relevant gateways that had previously received the response. For some embodiments, when a new device is added to a gateway, a notification is sent to the server, which analyzes all responses that were previously sent to that particular gateway. The server further analyzes whether any of those responses are to be updated with actions relating to the new device. If the server determines that any of those responses are to be updated (e.g., an update to a stored response is required), then the appropriate updates are sent to the gateway. One embodiment of this is shown with reference to FIG. 10.

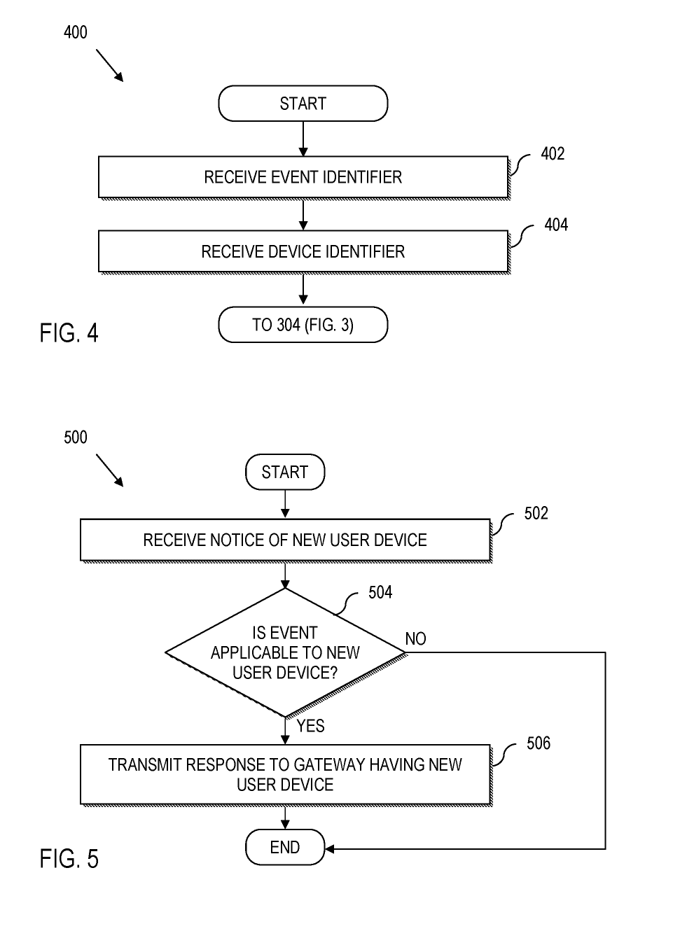

FIG. 4 is a flowchart showing an embodiment of the operation of receiving (302, FIG. 3) a request from a gateway by the server. In an embodiment, the server performs a computer-implemented process 400 that includes receiving at 402 an event identifier, and receiving at 404 a device identifier. The event identifier provides information on the event that occurred at the end device. In the example of a traffic accident, the device identifier indicates to the server that the end device is a GPS device, while the event identifier provides information on the location of the GPS device, the traffic conditions at that location, the date and time of the event, and any other event-related information that the end device transmits to the gateway. As noted above, the server uses the received request (302, FIG. 3) to generate the appropriate response. Thus, the server analyzes at 304, both the event identifier and the device identifier to determine which (if any) gateways should receive the response.

As further noted with reference to FIG. 3, the server communicates the response to all relevant gateways. When a new end device is communicably coupled to one of the gateways, the applicable gateway notifies the server, and the server transmits an applicable response to the associated gateway, as shown in the flowchart of FIG. 5. Briefly, if a new end device is coupled to one of the gateways, then the gateway notifies the server. Thus, as seen from the perspective of the server, the computer-implemented process 500 of FIG. 5, comprises receiving at 502 (by the server) notice of a new device from a gateway to which the new device has been communicatively coupled. Thereafter, the computer-implemented process 500 comprises determining at 504 whether or not the event (which was previously processed, FIG. 3) is applicable to the newly-added end device.

If the computer-implemented process 500 determines at 504 that the event is not applicable to the new end device, then no update is provided and the server-side process 500 ends. If, however, the computer-implemented process 500 determines at 504 that the event is applicable to the new end device, then the computer-implemented process 500 performs transmitting at 506 the response to the gateway having the new end device. Consequently, the gateway now has the response stored in its memory and is ready for a request from the new end device. As a result, when the gateway eventually receives a request, the gateway transmits the response (which can include an action corresponding to the event) to the end device without the need to forward the request to the server. As noted above, for some embodiments, when a new device is added to a gateway, a notification is sent to the server, which analyzes all responses that were previously sent to that particular gateway. The server further analyzes whether any of those responses are to be updated with actions relating to the new device. If any of those responses are to be updated (e.g., if an update to a stored response is required), then the appropriate updates are sent to the gateway. One embodiment of this is shown in greater detail with reference to FIG. 10.

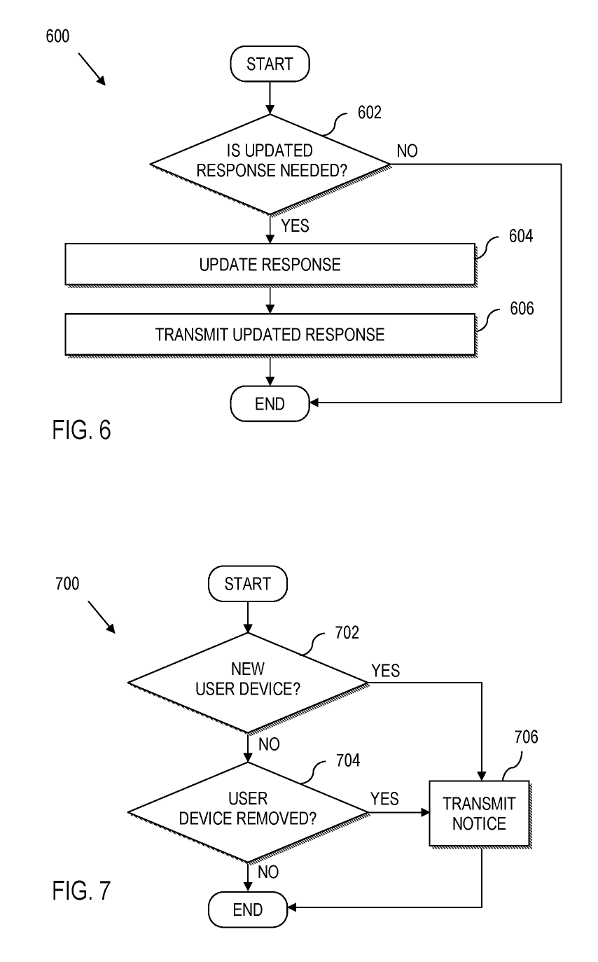

Some embodiments allow for updated responses when events or conditions change. FIG. 6 shows an embodiment of such a computer-implemented process 600 executed by the server. Under normal operating conditions, the server continues to receive requests based on events that occur at end devices. During normal operation, the computer-implemented process 600 performs determining at 602 whether or not an updated response is needed. If the computer-implemented process 600 determines at 602 that no updated response is needed, then the server continues normal operation without providing any updates. Conversely, if the computer-implemented process 600 determines at 602 that an updated response is needed, then the computer-implemented process 600 performs updating at 604 the response and generating an updated response. The computer-implemented process 600 then performs transmitting at 606 to each of the gateways that previously received the response. Consequently, the gateways have updated responses (rather than outdated or obsolete responses) to provide to the end devices.

Similar to how, in FIG. 5, the server is notified when a new end device is added to a gateway, the server is also notified when an existing end device is removed or uncoupled from a gateway. FIG. 7 is a flowchart showing an embodiment of such a computer-implemented process 700 from the perspective of a gateway. As shown in FIG. 7, the computer-implemented process 700 performs determining at 702 whether or not a new end device has been communicatively coupled to the gateway. If the computer-implemented process 700 determines at 702 that a new end device has been communicatively coupled to the gateway, then the computer-implemented process 700 performs transmitting at 706 a notice to the server. The computer-implemented process 700 also performs determining at 704 whether or not an existing end device has been uncoupled from the gateway. If the computer-implemented process 700 determines at 704 that an existing end device has been uncoupled from the gateway, then the computer-implemented process 700 performs transmitting at 706 a notice to the server.

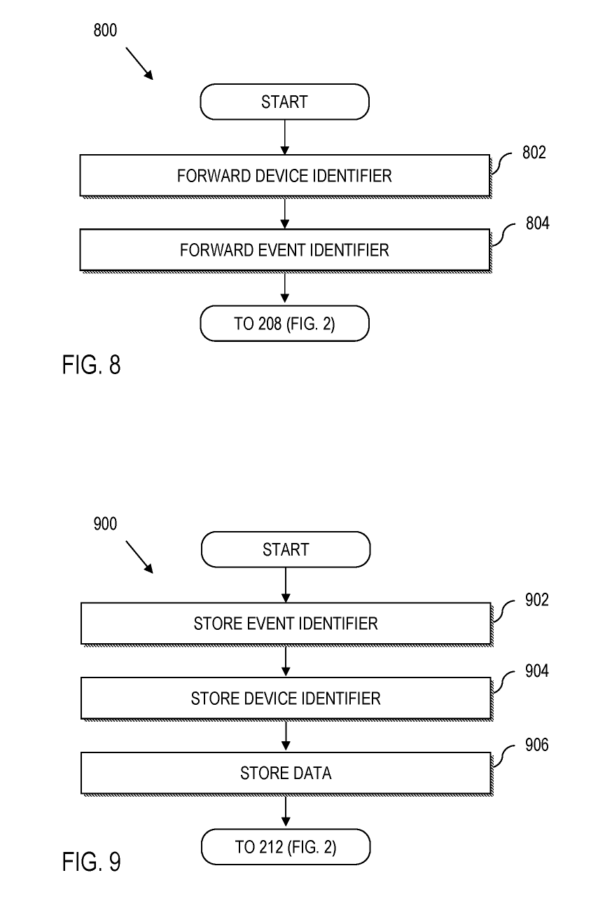

Recalling from FIG. 2 that the gateway forwards (206, FIG. 2) the request to the server, FIG. 8 is a flowchart showing an embodiment of a computer-implemented process for forwarding the request by a gateway to the server. In this regard, the computer-implemented process 800 of FIG. 8 is complimentary to the computer-implemented process 400 of FIG. 4.

As shown in FIG. 8, in an example implementation, two pieces of information are forwarded to the server. First, the computer-implemented process 800 performs forwarding at 802 a device identifier to the server, which indicates to the server the type of device (e.g., GPS) that corresponds to the end device. The computer-implemented process 800 also performs forwarding at 804 an event identifier to the server, which indicates to the server the event that occurred at the end device (e.g., traffic accident, etc.). As one can appreciate, the information forwarded via 802, 804 by the gateway corresponds to the information received via 402, 404 by the server.

FIG. 9 is a flowchart showing a computer-implemented process 900 performed by a gateway, which can be executed to implement an embodiment of the process of storing at 210 (FIG. 2) the response at the gateway. As shown in FIG. 9, the computer-implemented process 900 performs storing at 902 an event identifier, which corresponds to the event that occurred (e.g., traffic accident) at the end device. The computer-implemented process 900 also performs storing at 904 a device identifier, which corresponds to the end device (e.g., GPS). The computer-implemented process 900, as part of the response, also performs storing at 906, data. Using the example of the GPS, the stored data at 906 can include location, a new route, additional alternative routes, an updated arrival time, or a host of other information that is normally associated with GPS devices. It should be appreciated that the stored event identifier at 902 and the stored device identifier at 904 correspond to the information forwarded via 802, 804 (FIG. 8) by the gateway and the information received via 402, 404 (FIG. 4) by the server. The response can also optionally include a script, one or more actions, a data range, an array of device specific responses, or other information to respond appropriately to the corresponding request.

As explained with reference to FIGS. 2 and 3, by providing a response to multiple gateways before a request is received from all of them, the response time to end devices is reduced.

FIG. 10 is a flowchart showing a computer-implemented process 1000 at a gateway. As shown in FIG. 10, the computer-implemented process 1000 performs receiving at 1002 a response from the server without transmitting a request for the response. The computer-implemented process 1000 also performs storing at 1004, the response received at 1002, where the response is stored at the gateway. Thereafter, the computer-implemented process 1000 performs receiving at 1006 a request from an end device, and transmitting at 1008 the stored response to the end device without querying the server, thereby reducing the response time to the end device.

In an example implementation of the computer-implemented process 1000, storing the received response at the gateway comprises storing an event identifier, the event identifier corresponding to an event, storing a device identifier, the device identifier corresponding to the end device, and storing a script for generating data responsive to the event. This example implementation can also optionally further comprise receiving the request after receiving the first response, executing, upon receiving the request, the stored script to generate the data, and transmitting the generated data to the first end device.

In further example implementations, the computer-implemented process 1000 can further comprise receiving a second request from a second end device communicatively coupled to the first gateway, the second request being indicative of a second event. Moreover, the example computer-implemented process 1000 can further comprise determining, by the first gateway, whether a second response is stored in the memory of the first gateway, the second response being received from the server and stored in the memory of the first gateway when a previous request indicative of the second event was transmitted to the server by a second gateway, and transmitting, upon determining that the second response is stored in the memory of the first gateway, the stored second response to the second end device. Here, the computer-implemented process 1000 may optionally further comprise performing, upon determining that the second response to the second request is not stored in the memory of the first gateway, forwarding the second request to the server, receiving the second response to the second request from the server, storing the second response in the memory of the first gateway, and transmitting the stored second response to the second end device.

In yet a further example, the computer-implemented process 1000 can further comprise determining whether a new end device has been communicatively coupled to the first gateway, and transmitting, upon determining that the new device has been communicatively coupled to the first gateway, a notice to the server, receiving from the server a new updated response without transmitting a request for the new response, and storing the received new response at the gateway.

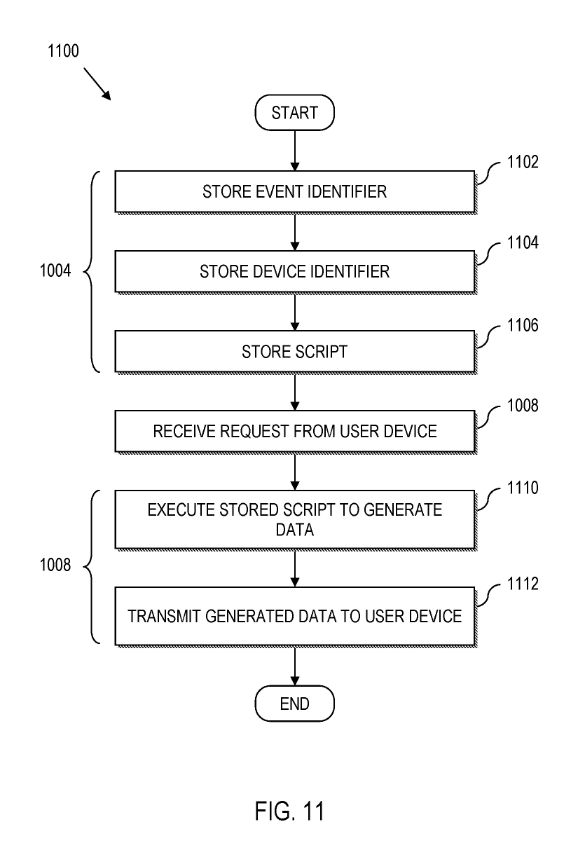

FIG. 11 is a flowchart showing a computer-implemented process 1100, as seen from the perspective of the gateway. Specifically, FIG. 11 shows in greater detail the steps of storing 1004 the response from the server, from FIG. 10, and transmitting 1008 the response to the end device, from FIG. 10. Consequently, in the computer-implemented process 1100 of FIG. 11, the computer-implemented process 1100 performs storing at 1102 an event identifier (as explained above), storing at 1104 a device identifier (as explained above), and storing at 1106 a script. The script is an executable code that instructs the gateway to perform an action that is related to the event that occurred at the end device, e.g., to generate the required response.

The computer-implemented process 1100 further performs receiving at 1008 a request (which corresponds to the now-stored response) from the end device, and executing the stored script at 1110 to generate data that addresses the event that occurred at the end device. The computer-implemented process 1100 further performs transmitting the generated data at 1112 to the end device.

The previously-stored response at the gateway, as described with reference to FIGS. 1 through 11, removes many of the queries to the server from different gateways, thereby reducing response times between the request and the response to the end device. FIG. 12 is a diagram showing one environment 1200 in which the computer-implemented processes of FIGS. 1 through 11 are implemented. As shown in FIG. 12, the example environment 1200 comprises a server 1202 (or a server bank). The server 1202 is communicatively coupled to multiple gateways 1204a, 1204b . . . 1204n (collectively, 1204). Each gateway 1204 is communicatively coupled to multiple end devices 1206a . . . 1206n (collectively, 1206). By way of example, one gateway 1204a (Gateway1) communicates with multiple end devices 1206a, 1208a, 1212a, including a GPS device 1210a (GPS1); another gateway 1204b (Gateway2) communicates with multiple end devices 1206b, 1208b, including a different GPS device 1210b (GPS2) and a sensor 1214a; yet another gateway 1204n (GatewayN) communicates with multiple end devices 1206n, 1208n, including yet another GPS device 1210n (GPS3) and another sensor 1214n; and so on.

Again, using the GPS example and applying it to an embodiment of the computer-implemented process (FIGS. 1 through 11) in the environment 1200 of FIG. 12, when GPS1 1210a experiences an event, such as a traffic accident, GPS1 1210a transmits a request to Gateway1 1204a. Gateway1 1204a receives 202 the request from GPS1 1210a. Gateway1 1204a then determines 204 whether or not there is a previously-stored response in the memory of Gateway1 1204a. If a previously-stored response exists, then Gateway1 1204a transmits 212 the previously-stored response to GPS1 1210a. If, however, no previously-stored solution exists on Gateway1 1204a, then Gateway1 1204a forwards 206 the request to the server 1202. The server 1202 receives 302 the request from Gateway1 1204a, analyzes 304 the received 302 request, and generates 306 a response, which is then transmitted back to Gateway1 1204a. The server 1202 further determines 310 whether or not the response is applicable to GPS2 1210b and GSP3 1210n. If the response is applicable to GPS2 1210b and GPS3 1210n, then the server 1202 communicates 312 the response to Gateway2 1204b and GatewayN 1204n.

Gateway1 1204a receives 208 the response from the server 1202 and stores 210 the response in its memory. The stored 210 response is then transmitted to GPS1 1210a. Gateway2 1204b also receives 1002 the response from the server 1202 and stores 1004 the received 1002 response in its memory. However, unlike Gateway1 1204a, the response at Gateway2 1204b is received 1002 before a request for the response has been transmitted to the server 1202 by Gateway2 1204b. Similar to Gateway2 1204b, GatewayN 1204n receives 1002 the response from the server 1202 without transmitting the request, and stores 1004 the response in its memory. Thereafter, when Gateway2 1204b receives 1006 a request from GPS2 1210b, Gateway2 1204b transmits the now-stored 1004 response to GPS2 1210b. Likewise, when GatewayN 1204n receives 1006 a request from GPS3 1210n, GatewayN 1204n transmits the now-stored 1004 response to GPS3 1210n.

Accordingly, gateway specific information is processed and is used to send proactive responses to other gateways. Thus, gateways receive responses to highly probable future events for devices connected thereto. This creates the possibility that the gateway will have a required response available even before the event is reported by any end device communicably coupled to the gateway. This will avoid the processing required after the event is received by the gateway and will reduce the time to communicate with the server (e.g., IoT platform) for the request and response hence reducing the overall response time.

In summary, a gateway captures a response to a request and adds the response to local storage within the gateway. On a next request from a device the gateway first checks its memory and if the request data is available then the response is sent from the gateway itself. This approach reduces the number of requests sent to the server hence the server can process and respond faster to other messages.

In an example implementation, the gateway stores values in terms of an event ID and corresponding data range or in terms of script which will generate the required response based on data available. If the values are outside the data range or no response is given by the script then the request can be forwarded to the server.

In an example implementation in an IoT environment, the end devices and the gateways do not typically have high processing power and are mainly dependent on the platform (server) for the data processing. Thus, the gateways act as a facilitator. Each gateway receives messages from each connected end device, converts those received messages into an http request which is then sent to the platform (server). Further, the gateways receive responses from the server and convert the received responses to device specific data/message format that are sent to the associated connected devices.

In the above-configuration, an example data buffer format on a gateway is as follows:

Request data:
Event id,
Device id,
Data format (Script/data range)
Script
Data range—from
Data range—to

Response data received by the gateway from the server can comprise an array of device specific responses, a script that is executable to generate the response, an array of device specific responses, etc., as noted more fully herein. Here, each device response will have a Device ID and an Action. For some embodiments, the request comprises a time-stamp and a usage count that is maintained for request data. In this embodiment, the server can validate and update the response based upon some predetermined cycle, interval, frequency, etc. For instance the server can validate and update the response on a regular time interval based upon time (e.g., once a day, etc.). Here, the server also deletes the response(s) that are no longer applicable, e.g., for being outdated or obsolete responses (e.g., responses related to devices that have been uncoupled from a gateway). For other embodiments, the time-stamp and usage information is used to clean the storage, e.g., to remove stored data when a gateway reaches a maximum allowed storage count, thereby storing or maintaining the recent responses and deleting relatively older responses. In yet further example embodiments, along with a timestamp, the gateway can also maintain information based upon a rule or rules, e.g., to maintain the last readings from each device, which can be used for the processing of scripts stored at gateway. Thus, it should be appreciated that the gateway, for some embodiments, maintains up-to-date device-related information that is useful for processing scripts that are stored on the gateway.

In some embodiments, the script depends on the gateway deployment environment. A sample script format is given below for a scenario where different actions are performed by end devices (gateway connected devices) based of a temperature reading reported by one of the devices:

If(device1.reading⇐t1)
Device1.action=action1;

Else if(device1.reading>t1 and device1.reading⇐t2)
Device1.action=action11;
Device2.action=action2;

Else if(device1.reading>=t2)
Device2.action=action22;
Device3.action=action3;

This example script will return a list of devices and an action to be performed for a particular temperature reading.

To ensure that the data stored by gateway is valid all the time, one or more of the following actions can be utilized. (1) When a new device is added to gateway the specific event will be sent to the platform which will reanalyze the response for the events which are stored on gateway storage. If any change is identified in the response/script then the gateway will be notified to update the stored data; (2) If any device is removed from the gateway then an event will be sent to platform but the reevaluation of stored messages is not required as any device specific messages can be discarded by gateway itself; (3) If any processing rules or actions are updated on the platform then the stored request/response will be reevaluated for each gateway and if any change is identified then those will be communicated back to the corresponding gateways.

Keeping with the above-example, the platform (server) keeps track of events that may be relevant to other gateways, especially for critical events. Based on the received events the platform should check to see if a received message is relevant to other gateways. The platform generates and sends the response to other gateways, e.g., each applicable gateway. If a gateway receives a message, (e.g., sensor reading, GPS information, smart appliance notification, etc.) that may be relevant to other gateways then the platform sends the event and response to those relevant gateways as well. This will ensure that the data is already available with gateways and hence when such event is received then the corresponding gateway can provide the response to the requesting device without any delays caused by processing and communicating with the platform.

By way of illustration, in certain embodiments, the server decides if a particular response needs to be distributed to other gateways based on parameters, such as: if other gateways also have the same or a similar device attached, which generates a similar event; if other gateways have a device which needs to perform an action based on the event; if the event received by one gateway is also applicable to other gateway environments; etc. This may be subjective to gateway deployment and specific information related to devices, gateways, other environmental factors, or combinations thereof. For example, if one vehicle identifies a road block, then this information will be applicable to all other vehicles moving in the same direction on the same road at about the same or close time. However, this information may not be applicable for vehicles moving in a different direction. The location of gateways may also be considered to identify the applicability.

As a few additional examples, in certain embodiments, critical events are defined and/or definable based on factors that may include the impact of the information, likelihood that the information will cause an impact, or perceived impact on a situation caused by the information, with the values and logic being specific to gateway deployment scenarios. In some embodiments, any specific reference about critical events can be avoided as such events define one of the criteria for a corresponding relevancy algorithm. In other embodiments, critical events can be used to define the priority order for the events processing and what all events should be maintained at gateways. Thus, for some embodiments, one or more criteria associated with event relevancy determines a priority for processing events, while in other embodiments similar relevancy criteria are used to determine which events, if any, should be maintained at gateways.

In this IoT example, if a vehicle meets with an accident then the vehicle GPS or other vehicle processor notifies the associated gateway. The gateway receives a response from the platform. The platform notifies other relevant gateways. However, the notification can be selective. For instance, the notification can apply only to vehicles moving in the same direction as the vehicle reporting the accident, and which are approaching the accident site within a predetermined time of the reported accident. Based on the event the other vehicles can be provided with the responses to take alternate route or change the lane etc. But these events can be triggered when it's really required, i.e., when vehicle is close to the site, and in an affected lane or direction of travel. Here, the platform can be pre-updated with such events or decision can be made by analyzing the historical data.

Notably, the processing of events for other gateways can be done in the background hence without affecting the performance or increasing the time delay for the gateway which sent the request. Also, the platform can apply logic to ignore events processing if similar events are received from multiple gateways as the corresponding event and response data is already available with gateways.

FIG. 13 is a diagram showing an embodiment of a schematic of a computer system 1300 comprising computer readable program code for executing any aspects described herein with regard to FIGS. 1 through 11. As such, FIG. 13 shows one example, among others, of a computer system by which the server 1202, the gateway 1204, the end device 1206, the GPS 1210, or the sensor 1214 is implemented. The computer system 1300 includes one or more microprocessors 1310 that are connected to memory 1320 via a system bus 1330. A bridge 1340 connects the system bus 1330 to an input-output (I/O) bus 1350 that links peripheral devices to the microprocessor(s) 1310. Peripherals may include storage 1360, such as a hard drive, removable media storage 1370, e.g., tape drive, floppy, flash, CD and/or DVD drive, I/O device(s) 1380 such as a keyboard, mouse, etc., and a network adapter 1390. In this regard, the microprocessor(s) 1310 may thus read computer instructions stored in the memory 1320, storage 1360, removable media storage 1370, or combinations thereof, to implement one or more of the aspects, as set out in greater detail herein.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, for some embodiments, aspects of the present disclosure are implemented entirely in hardware, entirely in software (including firmware, resident software, micro-code, etc.) or combining software and hardware implementation that are generally referred to herein as a “circuit,” “module,” “component,” “system,” or various combinations thereof. Furthermore, for other embodiments, aspects of the present disclosure take the form of a computer program product embodied in one or more computer readable media having computer readable program code embodied thereon.

For yet other embodiments, any combination of one or more computer readable media are utilized. The computer readable media, for some embodiments, comprise a computer readable signal medium or a computer readable storage medium. A computer readable storage medium is, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus, or device.

A computer readable signal medium includes a propagated data signal with computer readable program code embodied therein, for example, in baseband or as part of a carrier wave. Depending on the implementation, such a propagated signal takes any of a variety of forms, including, but not limited to, electro-magnetic, optical, or any suitable combination thereof. A computer readable signal medium is any computer readable medium that is not a computer readable storage medium and that can communicate, propagate, or transport a program for use by or in connection with an instruction execution system, apparatus, or device. Likewise, a computer readable storage medium is not a computer readable signal medium.

In some embodiments, computer program code for carrying out operations for aspects of the present disclosure is written in any combination of one or more programming languages, including an object oriented programming language such as Java, Scala, Smalltalk, Eiffel, JADE, Emerald, C++, CII, VB.NET, Python or the like, conventional procedural programming languages, such as the “c” programming language, Visual Basic, Fortran 2003, Perl, COBOL 2002, PHP, ABAP, dynamic programming languages such as Python, Ruby and Groovy, or other programming languages. Depending on the embodiment, the program code executes entirely on the user's computer, partly on the user's computer, as a stand-alone software package, partly on the user's computer and partly on a remote computer or entirely on the remote computer or server. In the latter scenario, the remote computer is connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, is implemented by computer program instructions for some embodiments. These computer program instructions are provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

In yet other embodiments, these computer program instructions are stored in a computer readable medium that when executed direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions, for some embodiments, are loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the drawings illustrate the architecture, functionality, and operation of possible implementations of systems, methods and computer program products according to various aspects of the present disclosure. In this regard, for some embodiments, each block in the flowchart or block diagrams represents a module, segment, or portion of code, which comprises one or more executable instructions for implementing the specified logical function(s). It should also be noted that, in some alternative implementations, the functions noted in the block occur out of the order noted in the drawings. For example, unless otherwise expressly noted or discernible by context, two blocks shown in succession are, for some embodiments, executed substantially concurrently, or the blocks are sometimes executed in reverse order, depending upon the functionality involved. It will also be noted that each block of the block diagrams and/or flowchart illustration, and combinations of blocks in the block diagrams and/or flowchart illustration, are implemented in some embodiments by special purpose hardware-based systems that perform the specified functions or acts, or combinations of special purpose hardware and computer instructions.

For clarity, and by way of example, which is not intended to limit the scope of this disclosure, the structures and functions associated with the server are implemented using one or more of the hardware, software, or combinations of hardware and software as recited herein. Similarly, the structures and functions associated with each of the gateways (e.g., first gateway, second gateway, additional gateways, etc.) are implemented using one or more of the hardware, software, or combinations of hardware and software as recited herein. Likewise, the structures and functions associated with each of the end devices (e.g., first end device, second end device, additional end device, sensor, etc.) are implemented using one or more of the hardware, software, or combinations of hardware and software as recited herein. Because those having ordinary skill in the art are familiar with the hardware and software and their implementation, as taught herein, and because those having skill in the art will be able to make and use the various embodiments based on the disclosure, further discussion of hardware and software with reference to the disclosed embodiments is omitted here.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A computer-implemented process comprising:
receiving, by a first gateway, a request that is indicative of an event associated with a first end device;
determining, by the first gateway, whether a response to the event is stored in memory of the first gateway; wherein:
if the response to the event is stored in the memory of the first gateway, the response was obtained by receiving, by the first gateway from the server, the response as a result of the server responding to a previous request indicative of the event from a second gateway; and
transmitting, upon determining that the response is stored in the memory of the first gateway, the response to the first end device.

2. The computer-implemented process of claim 1 further comprising:
performing, upon determining that the response to the request is not stored in the memory of the first gateway:
forwarding the request to the server;
receiving the response to the request from the server;
storing the response in the memory of the first gateway; and
transmitting the stored response to the first end device.

3. The computer-implemented process of claim 2, wherein forwarding the request to the server comprises:
forwarding to the server a device identifier, the device identifier being indicative of a device type that corresponds to the first end device; and
forwarding to the server an event identifier corresponding to the event.

4. The computer-implemented process of claim 2, wherein transmitting the response to the first end device comprises:
transmitting an action corresponding to the event.

5. The computer-implemented process of claim 2, wherein storing the response in the memory of the first gateway comprises:
storing an event identifier, the event identifier corresponding to the event; and
storing data comprising an action corresponding to the event to the first end device.

6. The computer-implemented process of claim 2 further comprising:
determining whether the first end device has been uncoupled from the first gateway; and
transmitting, upon determining that the first end device has been uncoupled from the first gateway, a notice to the server.

7. The computer-implemented process of claim 2 further comprising:
determining whether a new end device has been communicatively coupled to the first gateway; and
transmitting, upon determining that the new end device has been communicatively coupled to the first gateway, a notice to the server.

8. The computer-implemented process of claim 7 further comprising:
receiving, by the first gateway, a second response to a second event, the second response being received from the server without the first gateway transmitting a second request for the second response; and
storing the second response at the first gateway.

9. A computer-implemented process comprising:
receiving, by a first gateway, a response to an event, wherein:
the first gateway is communicatively coupled to a server;
the first gateway is communicably coupled to a first end device; and
the response is received from the server without the first gateway transmitting to the server, a request for the response; and
storing the received response at the first gateway.

10. The computer-implemented process of claim 9 further comprising:
receiving, by the first gateway, the request from the first end device after receiving the response from the server; and
transmitting, upon receiving the request, the stored response to the first end device.

11. The computer-implemented process of claim 9, wherein storing the received response at the first gateway comprises:
storing an event identifier, the event identifier corresponding to the event;
storing a device identifier, the device identifier corresponding to the first end device; and
storing a script for generating data responsive to the event.

12. The computer-implemented process of claim 11 further comprising:
receiving, by the first gateway, the request from the first end device, after receiving the response;
executing, upon receiving the request, the stored script to generate the data; and
transmitting the generated data to the first end device.

13. The computer-implemented process of claim 9 further comprising:
receiving a second request from a second end device communicatively coupled to the first gateway, the second request being indicative of a second event;
determining, by the first gateway, whether a second response is stored in the memory of the first gateway, the second response being received from the server and stored in the memory of the first gateway when a previous request indicative of the second event was transmitted to the server by a second gateway; and
transmitting, upon determining that the second response is stored in the memory of the first gateway, the stored second response to the second end device.

14. The computer-implemented process of claim 13 further comprising:
performing, upon determining that the second response to the second request is not stored in the memory of the first gateway:
forwarding the second request to the server;
receiving the second response to the second request from the server;
storing the second response in the memory of the first gateway; and
transmitting the stored second response to the second end device.

15. The computer-implemented process of claim 9 further comprising:
determining whether a new end device has been communicatively coupled to the first gateway;
transmitting, upon determining that the new end device has been communicatively coupled to the first gateway, a notice to the server;
receiving from the server a new updated response for the already stored responses, without transmitting a request for the new response; and
storing the received new response at the first gateway.

16. A computer-implemented process comprising:
receiving, by a server, a request from a first gateway, the request representing an event generated from a first end device in data communication with the first gateway;
analyzing, by the server, the received request;
generating a response to the analyzed request;
transmitting the generated response to the first gateway;
determining whether the event is applicable to a second device in data communication with a second gateway; and
communicating a second response to the second gateway upon determining that the event is applicable to the second device, the second response being communicated to the second gateway before the second gateway transmits to the server a second request representing the event.

17. The computer-implemented process of claim 16, wherein receiving, by the server, the request from the first gateway comprises:
receiving an event identifier, the event identifier being indicative of the event; and
receiving a device identifier, the device identifier corresponding to the first device, the device identifier further corresponding to applicable additional devices.

18. The computer-implemented process of claim 17, wherein transmitting the response to the first gateway comprises:
transmitting an executable script, the executable script configured to generate data, the generated data being responsive to the request.

19. The computer-implemented process of claim 16 further comprising:
receiving a new notice of a new device from an additional gateway;
determining, upon receiving the new notice, whether the event is applicable to the new device; and
transmitting the response to the additional gateway upon determining that the event is applicable to the new device.

20. The computer-implemented process of claim 16 further comprising:
determining whether an update to the response is needed;
updating, upon determining that the update is needed, the response to generate an updated response; and
transmitting the updated response to each gateway that had previously received the response.
